(19) United States
(12) Patent Application Publication
(10) Pub. No.: US 2022/0371278 A1
(43) Pub. Date: Nov. 24, 2022

(54) NON-POWERED PLATFORMS

(71) Applicant: Hewlett-Packard Development Company, L.P., Spring, TX (US)

(72) Inventors: Pau MARTIN VIDAL, Sant Cugat del Valles (ES); Marius VALLES GONZALEZ, Sant Cugat del Valles (ES); Gerard MOSQUERA DONATE, Sant Cugat del Valles (ES); Albert RODRIGUEZ FERNANDEZ, Sant Cugat del Valles (ES); Gabriel DE LA CAL MENDOZA, Sant Cugat del Valles (ES); Francesc MELIA SUNE, Sant Cugat del Valles (ES)

(73) Assignee: Hewlett-Packard Development Company, L.P., Spring, TX (US)

(21) Appl. No.: 17/770,961

(22) PCT Filed: Jan. 30, 2020
(86) PCT No.: PCT/US2020/015891

§ 371 Date: Apr. 21, 2022

(51) Int. Cl. B29C 64/321; B33Y 30/00; B29C 64/255; B29C 64/245; B29C 64/232; B29C 64/295; B33Y 40/00

(52) U.S. Cl. CPC B29C 64/321; B33Y 30/00; B29C 64/255; B29C 64/245; B29C 64/232; B29C 64/295; B33Y 40/00

(57) ABSTRACT

A 3D printing apparatus is disclosed herein. The 3D printing apparatus comprises a build compartment defining a build chamber within which a 3D object is to be generated; and a non-powered platform, moveable within the build chamber, comprising a platform drive interface to engage with an external drive mechanism to cause the platform to move. The 3D printing apparatus further comprises a powder compartment located laterally adjacent to the build compartment, within which build material is to be stored for use in the generation of the 3D object. The 3D printing apparatus also comprises a locking interface to couple the 3D printing apparatus with an external hosting device.

### BACKGROUND

Some additive manufacturing or three-dimensional printing systems comprise a removable build unit that interacts with different 3D printing system sub-systems. Some build units comprise a build chamber defining a volume where 3D objects are generated. The build chamber comprises a build platform to perform a 3D printing operation in interaction with the 3D printing sub-system in which the build unit resides.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printing apparatus with a non-powered platform;

FIG. 2A is a schematic diagram showing an example of a 3D printing apparatus with a plurality of powder compartments;

FIG. 2B is a schematic diagram showing an example of another 3D printing apparatus with a non-powered platform and a non-powered feeding platform;

FIG. 2C is a schematic diagram showing an example of another 3D printing apparatus with a non-powered platform and an Archimedes screw interface;

FIG. 3 is a schematic diagram showing an example of a hosting device to receive a 3D printing apparatus with a non-powered platform;

FIG. 4A is a schematic diagram showing an example of a hosting device to receive a 3D printing apparatus with a non-powered platform and a non-powered feeding platform;

FIG. 4B is a schematic diagram showing an example of a hosting device with an Archimedes screw to receive a 3D printing apparatus with a non-powered platform; and

FIG. 5 is a flowchart of an example method or generating a layer of build material in a 3D printer engaged with a 3D printing apparatus

### DETAILED DESCRIPTION

The following description is directed to various examples of additive manufacturing, or three-dimensional printing, apparatus and processes to generate high quality 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

Some elements in the examples shown herein are drawn in dotted lines to indicate that the elements are external but interact with the apparatuses or devices being disclosed therein.

3D printing systems generate a 3D object by executing a series of 3D printing operations. In some 3D printing systems some of the 3D printing operations are distinct from each other, and may be executed by different sub-systems of the 3D printing system. The sub-systems may be different depending on the type of material and 3D printing technology used. Some sub-systems may be physically placed in different locations.

Some removable build units may be attached and detached from the different sub-systems according to the 3D printing system workflow. A build unit may be understood as the module including a build chamber where 3D objects are to be generated during the 3D printing process of a 3D printing system.

Some 3D printing operations may include at least one of loading the removable build unit with build material, heating part of the build unit, selectively solidifying portions of build material from the build unit, ejecting agents (e.g., binding agents, fusing agents) to portions of the build material from the build unit, curing the contents of a build unit (e.g., thermally or UV curing), thermally fusing the portions of build material in which fusing agents have been deposited, separating non-solidified build material from the generated 3D objects (i.e., decaking), recycling non-solidified build material, removing 3D objects from the build unit, cleaning the build unit, and the like.

Some sub-systems may perform at least one of the printing operations mentioned above may include at least one of a build material processing station, a 3D printer, a curing station, a cleaning station, a decaking station and the like.

Some 3D systems generate 3D objects by selectively processing layers of build material. Suitable powder-based build materials for use in additive manufacturing may include, where appropriate, at least one of polymers, metal powder or ceramic powder. In some examples build materials may be provided in other forms, such as gels, pastes, and slurries.

As mentioned above, build units may be attached to and detached from different sub-systems in which different 3D printing operations are executed. Typical build units are technically complex independent modules that interact with the different sub-systems of a 3D system. Build units comprise a moveable build platform therein to assist in the 3D printing operations execution. Some build units comprise additional mechanisms and equipment to further assist in the 3D printing operations execution. For example, some build units comprise heaters (e.g., resistive heaters or heating blankets) to transfer heat to the contents of the build unit and thereby maintain them at a constant or controlled temperature. Build units also comprise a build platform drive mechanism to cause the movement of the build platform. Hence, build units may comprise expensive and complex equipment that execute 3D printing operations when the build unit is engaged in the appropriate 3D printing sub-system. A fleet of multiple build units raises the cost a 3D printing system since the aforementioned expensive and complex equipment is replicated in each build unit.

A single build unit may be used by different sub-systems to perform different printing operations. Some build unit elements and mechanisms are expensive and are not used in every single sub-system that the build unit interacts with. For this reason, some expensive build unit mechanisms may be used infrequently throughout a complete build unit use cycle.

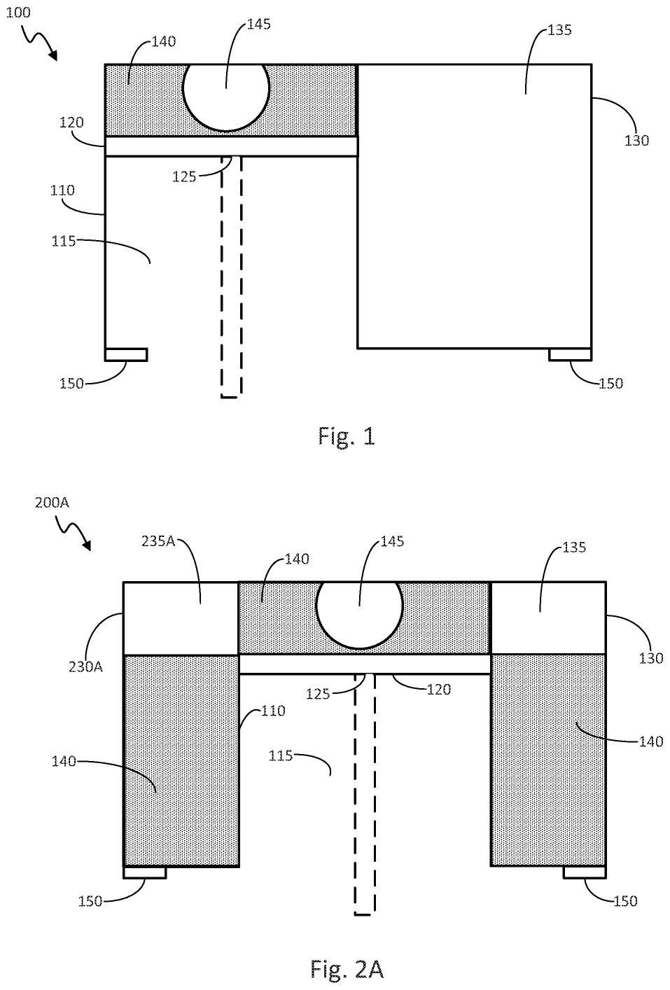

Referring now to the drawings, FIG. 1 is a is a schematic diagram showing an example of a vertical cross-section of a 3D printing apparatus 100.

The 3D printing apparatus 100 comprises a build compartment 110 defining a build chamber 115 therein. In some examples, the build compartment 110 comprises a lateral wall or a plurality of lateral walls. Additionally, in some examples, the build compartment 110 may additionally comprise a top wall and/or a bottom wall. A top wall may be implemented in the form of a removable sealable lid. The horizontal cross-section of the build compartment 110 may be rectangular, circular, rectangular with rounded corners, or any other shape suitable for the generation of a 3D object therein.

When in use, a 3D printer may generate a 3D object 145 out of build material 140 in the build chamber 115. When it is not in use, the 3D printing apparatus 100 may not comprise build material 140 nor a 3D object 145.

The 3D printing apparatus 100 comprises a non-powered platform 120 in the build chamber 115. For simplicity, the non-powered platform 120 may be referred hereinafter as platform 120. The platform 120 is not powered meaning that the apparatus 100 does not comprise any electronic element or circuitry to move the platform 120.

The platform 120 may be externally controlled to move within the build chamber 115 according to the examples of the present disclosure. The platform 120 comprises a platform drive interface 125 engageable with an external drive mechanism (shown in dotted lines) to cause the platform 120 to move. 100 The drive mechanism is part of an external system engageable with the 3D printing apparatus 100 (e.g., a hosting device). In an example, the external drive mechanism is controllable to move the platform 120 vertically upwardly and downwardly. In other examples, however, the external drive mechanism may also move the platform laterally or rotate (e.g., tilt) the platform 120 with respect to a horizontal plane.

The 3D printing apparatus 100 further comprises a powder compartment 130 defining a feeding volume 135 therein. The powder compartment 130 is located laterally adjacent to the build compartment 110. In some examples, a lateral wall from the powder compartment 130 is in direct contact with a lateral wall from the build compartment 110. In other examples, there may be an intermediate element between the lateral wall from the powder compartment 130 and the lateral wall from the powder compartment 130. When in use, the powder compartment 130 is to store build material 140 to be used in the generation of the 3D object 145. Therefore, the feeding volume 135 is designed to store enough build material 140 to generate the 3D object 145. In some examples, the feeding volume 135 may be about the same size as the build chamber 115. In other examples, the feeding volume 135 may be bigger in size then the build chamber 115.

The 3D printing apparatus 100 may be configured as a non-powered single transportable element. The 3D printing apparatus 100 may be transportable and engageable with different 3D printing sub-systems. In an example, the 3D printing apparatus 100 is suitable to be used in 3D printing operations in a 3D printer, a build material processing station, a decaking station, a curing station, and the like. Therefore, the 3D printing apparatus 100 may be engageable with different hosting devices located at different 3D printing sub-systems. 100 A more detailed description of the hosting device is disclosed in some of the examples below.

The 3D printing apparatus 100 also comprises a locking interface 150 configured to couple the 3D printing apparatus 100 with the external hosting device. The locking interface 150 is engageable with a locking mechanism (not shown) from the external hosting device to secure and release the 3D printing apparatus 100 from the hosting device. The locking interface 150 thereby allows the 3D printing apparatus 100 to be transportable and engageable with different hosting devices from different 3D printing subsystems as disclosed above.

The external locking mechanism may engage with the locking interface 150 in a number of different ways. In an example, the external locking mechanism is a mechanical system actuatable between its locked and released positions. In another example, the external locking mechanism comprises electronic components that enables it to be controlled by an external controller (not shown) to switch between its locked and released positions. Some examples, of locking mechanisms include latches and/or pins.

In an example, the 3D printing apparatus 100 may engage with a 3D printer. When the 3D printing device 100 is engaged with the 3D printer and the 3D printer is in use, the build platform 120 may be externally controlled to move to a top part of the build compartment 110. Then, an external layer forming element from the hosting device (not shown) may convey build material 140 from the feeding volume 135 to the top part of the powder compartment 130. The uppermost top part of the powder compartment 130 may be aligned with the uppermost top part of the build compartment 110. Some examples of the external layer forming element are disclosed with reference to FIGS. 5A and 5B. The external layer forming element may convey an amount of build material 140 suitable for generating a layer of build material 140 on the build platform 120. The amount of build material may be determined based on, at least in part, the surface area of the platform 120 and a predetermined thickness of the layer to be generated. Once the amount of build material 140 is conveyed to the top part of the powder compartment 130, a recoating element from the 3D printer (e.g., roller, wiper, doctor blade) may spread the amount of build material 140 on the build platform 120 to generate a layer of build material thereon.

Once the layer of build material 140 has been generated, a selective solidification module (not shown) from the 3D printer may selectively solidify portions of the uppermost layer to generate the part of the 3D object 145 corresponding to the generated layer. Then, the build platform 120 may be externally controlled to move (e.g., downwards) for a distance corresponding to a thickness of the subsequent layer to be generated. The same printing operations may be executed up to the completion of the 3D object 145.

The selective solidification module may selectively solidify portions of the uppermost layer of build material in a number of different ways. In an example, the selective solidification module may selectively solidify portions of a layer of build material in a layer-by-layer basis by depositing printing fluids (e.g., fusing agents, fusing modifying agents, property agents, colour agents). In other examples, the selective solidification module may comprise a laser or a laser array to directly selectively solidify portions of a layer of build material; e.g., Selective Laser Sintering (SLS). In other examples, the selective solidification module may selectively deposit binding agents (e.g., thermally curable binder agents, UV curable binder agents) to a layer of build material in a layer-by-layer basis. In yet other examples, the selective solidification module may use other 3D printing techniques to generate a 3D object, for example, Stereolithography (SLA), Digital Light Processing (DLP), Selective Laser Melting (SLM), or the like.

In an example, the build compartment 110 is made at least in part of a material with high thermal conductivity. Materials with high thermal conductivity allow heat to be transferred therethrough more efficiently. The build unit housing 120 may be made of a material with a thermal conductivity of at least 10 W/(m·K), for example, Aluminum 235 W/(m·K), Brass 109 W/(m·K), Copper 401 W/(m·K), Iron 67 W/(m·K), Lead 35 W/(m·K), Nickel 91 W/(m·K), Stainless Steel 14 W/(m·K), Steel (carbon 1%) 43 W/(m·K) or any other material suitable to transfer heat therethrough in an efficient manner.

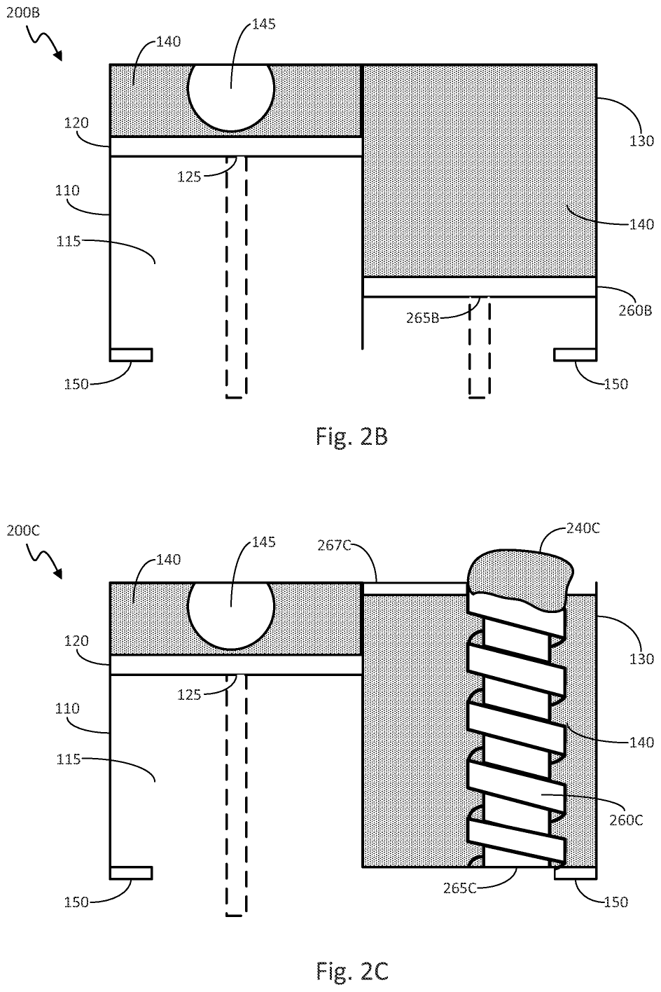

FIG. 2A is a schematic diagram showing a vertical cross-section of an example of a 3D printing apparatus 200A. The 3D printing apparatus 200A comprises the build compartment 110 defining the build chamber 115, the build platform 120 with the platform drive interface 125, the powder compartment 130, and the locking interface 150. Additionally, when in use, the 3D printing apparatus 200A may further comprise the 3D object 145 and build material 140.

The 3D printing apparatus 200A further comprises an additional powder compartment 230A. The additional powder compartment 230A may be similar to the powder compartment 130 and may perform the same functionality. The additional powder compartment 230A defines an additional feeding volume 235A therein to store build material 140 to be subsequently used in the generation of a 3D object 145. In an example, the combined volumes of the feeding volume 135 and the additional feeding volume 235A are about the same volume as the build chamber 115. In another example, the combined volumes of the feeding volume 135 and the additional feeding volume 235A are a bigger volume than the build chamber 115.

The additional powder compartment 230A has the same functionality as the powder compartment 130, namely to convey an amount of build material 140 from the additional powder compartment 230A to the top part of the additional powder compartment 230A so that it can be subsequently recoated to generate a layer of build material in the build chamber 115.

The additional powder compartment 230A is located laterally adjacent to the build compartment 110 and at the opposite side from the powder compartment 130 with respect to the build compartment 110. This arrangement enables the conveying system from a 3D printer to spread build material in two directions, namely a first direction from the powder compartment 130 to the additional powder compartment 230A, and a second direction from the additional powder compartment 230A to the powder compartment 130. In the examples in which the selective solidification module can selectively solidify layers of build material in a time corresponding to a single pass of the recoating mechanism from a first end of the build chamber to a second end, a dual direction recoating enables a faster generation of build material layers compared to spreading from a single side, thereby generating printing of the 3D object 145 in a faster way.

FIG. 2B is a schematic diagram showing an example of a vertical cross-section of another 3D printing apparatus 200B. The 3D printing apparatus 200B comprises the build compartment 110 defining the build chamber 115, the build platform 120 with the platform drive interface 125, the powder compartment 130, and the locking interface 150. When in use, the 3D printing apparatus 200B further comprises the 3D object 145 and build material 140.

The 3D printing apparatus 200B comprises a non-powered feeding platform 260B in the feeding volume 135. For simplicity, the non-powered feeding platform 260B may be referred hereinafter as feeding platform 260B. The feeding platform 260B is not powered meaning that the apparatus 265B does not comprise any electronic element or circuitry to move the feeding platform 260B260B The feeding platform 260B is externally controllable to move within the feeding volume 135.

The feeding platform 260B comprises a feeding platform drive interface 265B to engage with an external powder feeding platform drive mechanism (not shown) from a hosting device. In an example, the feeding platform drive interface 265B comprises a first central planar section designed to be in direct contact with the top section of the external feeding platform drive mechanism, and a second section at the edge of the feeding platform drive interface 265B designed as a mechanical grip to secure the feeding platform drive interface 265B with the external feeding platform drive mechanism. In another example, the feeding platform drive interface 265B may include an electromagnet 265B that be can be externally actuated to secure the feeding platform drive interface 265B to the external feeding platform drive mechanism.

It should be noted that the 3D printing apparatus 200B does not comprise any powder feeding platform drive mechanism therein since the drive mechanism is included in an external system (such as a 3D printing sub-system)200B. When in use, the external powder feeding platform drive mechanism controls the feeding platform 260B to move within the powder compartment 130. In an example, the external powder feeding platform drive mechanism controls the feeding platform to move vertically upwardly and/or downwardly. In other examples, however, the external powder feeding drive mechanism may also move the feeding platform 260B laterally or rotate (e.g., tilt) the platform 120 with respect to a horizontal plane.

As mentioned above, in the example in which the 3D printing apparatus 265B is engaged with a 3D printer, layers of build material are formed on the build platform 120. In order to generate a layer of build material, the external feeding platform drive mechanism may cause the feeding platform 260B to move upwardly for a distance so that the amount of build material 140 to generate the layer of build material is accessible to the layer forming element from the 3D printer. Then the layer forming element is to convey the amount of build material 140 suitable for the generation of the build material layer on the build platform 120 or onto a previously generated build material layer. This procedure may be repeated for each build material layer to be generated up to the completion of the 3D object 145 or the completion of the print job.

For the generation of build material layers, the feeding volume 135 should be filled with build material 140. Build material 140 may be loaded into the feeding volume 135 by inserting the 3D printing apparatus 200B into a build material processing station. A build material processing station is a 3D printing sub-system that conveys build material from a build material reservoir to the powder compartment 130. In the example, the external powder feeding platform drive mechanism may cause the feeding platform 260B to move downwardly so that the 3D printing build material processing station may fill the feeding volume with build material for the generation of a 3D object. The 3D printing apparatus 200B may then disengage from the hosting device of the 3D printing build material processing station and be transported to a 3D printer to be further engaged therewith.

Once the 3D printing apparatus 200B is engaged a 3D printer, and when the 3D printer is in use, an external powder feeding platform drive mechanism may control the feeding platform 260B to move vertically to make an amount of build material accessible to a recoating element from the 3D printer, so that the recoating element may subsequently generate a layer of build material on the build platform 120. In the example, the powder feeding platform drive mechanism may cause the feeding platform 260B to move vertically upwardly for a distance corresponding to the amount of build material to generate the layer of build material.

FIG. 2C is a schematic diagram showing an example of a vertical cross-section of another 3D printing apparatus 200C. The 3D printing apparatus 220B may be an alternative implementation of the 3D printing apparatus 200B. The 3D printing apparatus 200C comprises the build compartment 110 defining the build chamber 115, the build platform 120 with the platform drive interface 125, the powder compartment 130, and the locking interface 150. Additionally, when in use, the 3D printing apparatus 200C further comprises the 3D object 145 and build material 140.

The 3D printing apparatus 200C comprises an Archimedes screw 260C in the feeding volume 135 with an Archimedes screw interface 265C. The Archimedes screw interface 265C is engageable with an external Archimedes screw drive mechanism (not shown) from a 3D printing subsystem. An Archimedes screw is a helical surface surrounding a central cylindrical shaft that is rotatable to move build material up the length of the screw. The Archimedes screw 260C may be externally controllable through the Archimedes screw interface 265C to transport build material 140 from the bottom of the powder compartment upwards and towards a powder holder 267C, where the build material is accumulated 240C.

The powder holder 267C is a surface located at a top part of the powder compartment 130 to accumulate an amount of build material 240C thereon. A recoating mechanism may spread the accumulated amount of build material 240C to generate a layer of build material on the build platform 120 or onto the uppermost build material layer from the build chamber 115.

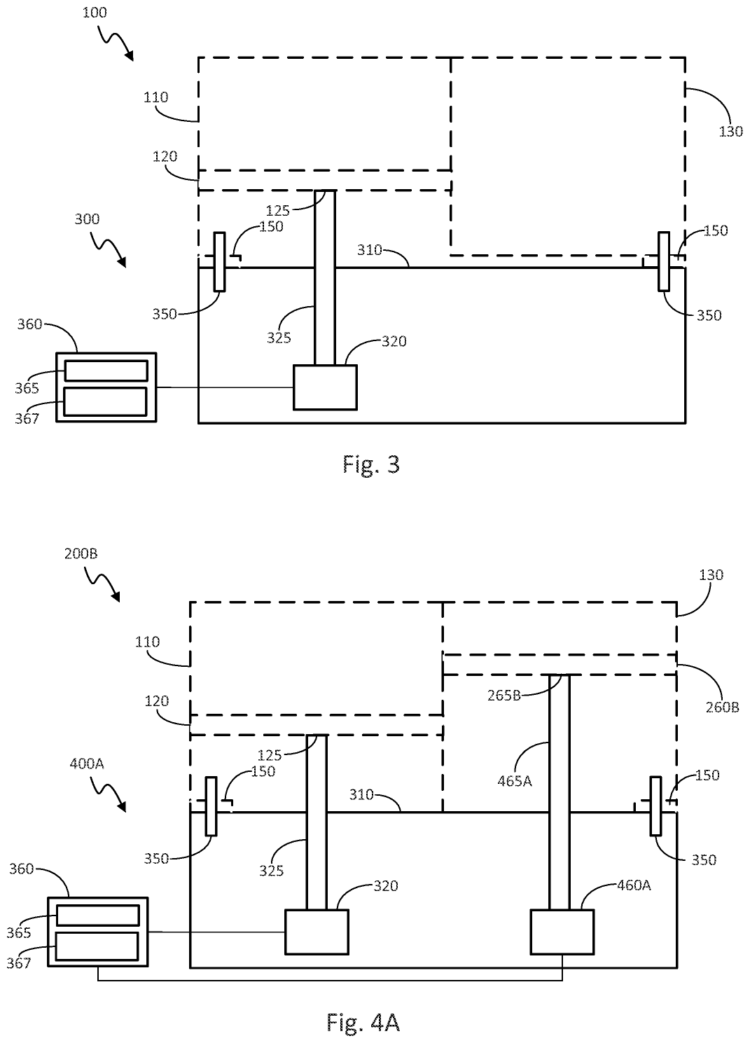

FIG. 3 is a schematic diagram showing an example of a vertical cross-section of a hosting device 300. The hosting device 300 is to receive the 3D printing apparatus 100. The 3D printing apparatus 100 to be received comprises the build compartment 110 and the powder compartment 130 laterally adjacent with each other, the build platform 120 and the locking interface 150. Examples herein refer to the 3D printing apparatus 100, however it is to be understood that the reference may be made to the 3D printing apparatus 200B, 200C and 200A instead, without departing from the scope of the present disclosure.

The hosting device 300 may be included in a 3D printer sub-system. In an example, the hosting device 300 is a part of a 3D printer. In another example, the hosting device 300 is part of a 3D build material processing station. In another example, the hosting device 300 is part of a 3D printing decaking station where un-solidified build material is separated from the already generated 3D objects. In yet another example, the hosting device 300 is part of a 3D printing curing station.

The hosting device 300 comprises a 3D printing apparatus receiving interface 310 to receive the external 3D printing apparatus 100 thereon. For simplicity, the 3D printing apparatus receiving interface 310 may be referred hereinafter as receiving interface 310. In an example, the receiving interface 310 is a horizontal surface located at the top part of the hosting device 300 so that the bottom part of the 3D printing apparatus 100 is accommodated to be subsequently secured thereon. In other examples, the receiving interface 310 may be of any other suitable shape to accommodate the 3D printing apparatus 100 to the hosting device 300.

The hosting device 300 further comprises a locking mechanism 350 which is engageable with the locking interface 150 from the 3D printing apparatus 100. The locking mechanism 350, in its engaged position, is to secure the 3D printing apparatus 100 to the hosting device 300. However, the locking mechanism 350, is its disengaged position, is to release the 3D printing apparatus 100 from the hosting device 300. The locking mechanism 350 and the locking interface 150 may be implemented in a number of different ways. In an example, the locking mechanism 350 is a mechanic system actuatable between its locked and released positions. In other examples, however, the locking mechanism 350 comprises electronic components that enables the locking mechanism 350 to be controlled by a controller 360 to switch between its locked and released positions. Some examples of locking mechanism 350 may include latches, pins, or any mechanism capable to hold or secure the 3D printing apparatus 100 in the appropriate position with respect to the receiving interface 310.

The hosting device 300 comprises a drive mechanism 325 engageable with the non-powered platform 120 from the 3D printing apparatus 100 to cause the platform 120 to move. The drive mechanism 325 may be the same as or similar to the external drive mechanism disclosed in the examples with reference to FIG. 1. The drive mechanism 325 may be any mechanism suitable for causing the platform 120 to move in a controlled manner. In an example, the drive mechanism 325 comprises a piston coupled to a rotating device 320 (e.g., motor). The rotating device 320 rotates to control the height of the piston and thereby control the height of the platform 120.

In some examples, the drive mechanism 325 further comprises a heating element (not shown), such as a heating resistor or a heating blanket. When in use, the heating element may generate and transfer heat to the platform 120. The platform 120 is thereby heated and part of such heat is further transferred to the bottom layers of build material 140 generated on the platform 120.

In these examples, the hosting device 300 further comprises a controller 360. The controller 360 comprises a processor 365 and a memory 367 with specific control instructions to be executed by the processor 365. The controller 360 may be coupled to the driving mechanism 325 (or the rotating device 320 connected to the driving mechanism 325). Additionally, the controller 360 may be also coupled to a locking mechanism 350 with electronic components. The controller 360 controls the driving mechanism 325 to move the platform 120 within the build compartment 110 of the 3D printing apparatus 100. The controller 360 may also control the engagement between the driving mechanism 325 and the platform drive interface 125. The functionality of the controller 360 is described further below, for example, with reference to the method of FIG. 5.

In the examples herein, the controller 360 may be any combinations of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller 360 may be a distributed controller, a plurality of controllers, and the like.

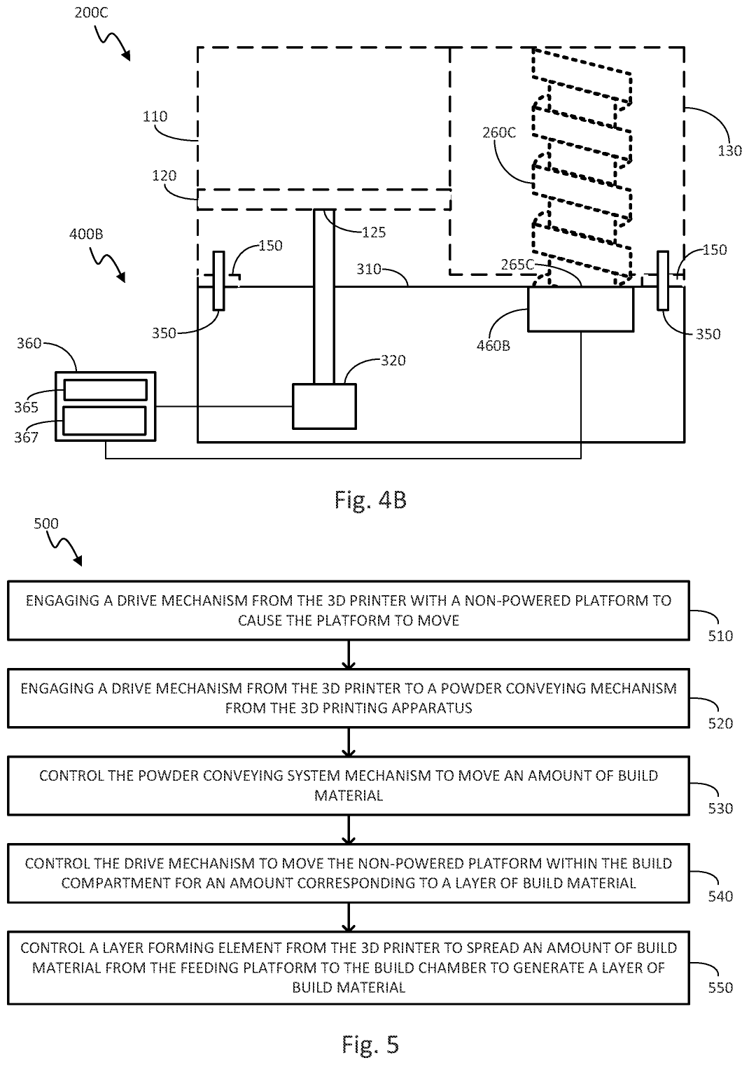

FIG. 4A is a schematic diagram showing a vertical cross-section of an example of a hosting device 400A to receive the 3D printing apparatus 265B. The hosting device 400A may be similar as the hosting device 300. The hosting device 400A comprises the receiving interface 310 suitable to receive the 3D printing apparatus 265B, the locking mechanism 350, the drive mechanism 325 and the controller 360. Additionally, the hosting device 400A may also comprise the rotating device 320 according to the examples disclosed above.

The hosting device 400A further comprises a powder feeding platform drive mechanism 465A. For simplicity, the powder feeding platform drive mechanism 465A may be referred hereinafter as feeding drive mechanism 465A. The feeding drive mechanism 465A is engageable with the non-powered feeding platform 260B located in the powder compartment 130 from the 3D apparatus 265B. The non-powered feeding platform 260B is not part of the hosting device 400A. The feeding drive mechanism 465A is engageable to the feeding platform 260B through the feeding platform drive interface 265B to cause the feeding platform 260B to move. The feeding drive mechanism 465A may have the same functionality as the external layer forming element disclosed above. The feeding drive mechanism 465A may be any mechanism suitable for causing the feeding platform 260B to move in a controlled manner. In an example, the feeding drive mechanism 465A comprises a piston coupled to a rotating device 460A (e.g., motor). The rotating device 460A rotates to control the height of the piston and thereby control the height of the feeding platform 260B.

The feeding drive mechanism 465A is connected to the controller 360. The controller 360 is therefore to control the feeding drive mechanism 465A to move the feeding platform 260B for a predetermined distance.

In the example in which the hosting device 400A is in a 3D build material processing station, the predetermined distance is a distance that sets the feeding platform 260B a low height level within the powder compartment 130 (e.g., the lowest height within the powder compartment 130), so that the 3D build material processing station may subsequently fill in the feeding volume 135 with build material 140.

In the example in which the hosting device 400A is in a 3D printer, the predetermined distance is based on an amount of build material to generate a layer of build material on the build platform 120. Therefore, to generate a build material layer on the platform 120, the controller 360 may control the feeding drive mechanism 465A to raise the feeding platform 260B so that an amount of build material to generate a layer of build material on the build platform 120 is accessible to a recoating mechanism. The controller 360 (or any other controlling device from the 3D printer) may then control the recoating mechanism to recoat and thereby generate a layer of build material on the platform 120; and may additionally control the 3D printer to selectively solidify portions of the generated build material layer based on the 3D object to be generated. The controller 360 may then control the drive mechanism 325 to cause the build platform 120 to lower down for a distance corresponding to the thickness of the subsequent layer of build material to be generated. In some examples, the thickness of the layer to be generated may range from about 30 to about 120 microns, for example 50 microns or 80 microns. The controller may repeat this procedure up to the generation of the 3D object.

FIG. 4B is a schematic diagram showing a vertical cross-section of an example of a hosting device 400B to receive the 3D printing apparatus 200C. The hosting device 400B may be similar as the hosting device 300. The hosting device 400B comprises the receiving interface 310 suitable for receiving the 3D printing apparatus 200C, the locking mechanism 350, the drive mechanism 325 and the controller 360. Additionally, the hosting device 400A may also comprise the rotating device 320 according to the examples disclosed above.

The hosting device 400B also comprises the Archimedes screw drive mechanism 460B which may be implemented in the form of a rotating device (e.g., a motor). The Archimedes screw 465B is coupled to the Archimedes screw drive mechanism 460B which is to rotate, and thereby transmit a rotation to the Archimedes screw 465B. The rotation of the Archimedes screw 465B causes the transportation of the build material 140 from the powder compartment 130 to the powder holder 267C where the build material accumulates to be subsequently recoated to generate a build material layer on the build chamber 115. The controller 360 is coupled to the Archimedes screw drive mechanism 460B. The controller 360 is to control the Archimedes screw drive mechanism 460B to rotate for a predetermined amount, so that the rotation is transferred to the Archimedes screw 260C through the Archimedes screw drive interface 265C, to accumulate build material on the powder holder 267C. The predetermined amount may correspond to the rotation amount that causes that enough build material 140 is accumulated on the powder holder 267C to generate a build material layer on the build platform 120.

FIG. 5 is a flowchart of an example method 500 for generating a layer of build material in a 3D printer engaged with a 3D printing apparatus, for example, the 3D printing apparatus 100 from FIG. 1. In some examples, method 500 may be executed by the controller 360.

Method 500 may be started when at least some build material 140 is previously loaded in the feeding volume 135.

At block 510, the controller 360 engages the drive mechanism 320 from the 3D printer with a non-powered platform 120 to cause the platform 120 to move.

At block 520, the controller 360 engages a drive mechanism from the 3D printer to a powder conveying mechanism (e.g., feeding platform 260B from FIG. 2B, Archimedes screw 260C from FIG. 2C) from the 3D printing apparatus. In an implementation of block 520, the controller 360 engages with the feeding platform drive mechanism 460A from the 3D printer with a non-powered feeding platform 260B to cause the feeding platform to move. In another implementation of block 520, the controller 360 engages the Archimedes screw mechanism 460B with the Archimedes screw 260C to move build material upwardly through the rotation of the Archimedes screw.

At block 530, the controller 360 controls the powder conveying mechanism to move an amount of build material upwardly. In an implementation of block 530, the controller 360 controls the feeding platform drive mechanism 460A to move the non-powered feeding platform 260B for a predetermined distance corresponding to an amount of build material 140 to generate a layer of build material. In another implementation of block 530, the controller 360 controls the Archimedes screw drive mechanism 460B to rotate the Archimedes screw 260C for a predetermined amount corresponding to the rotation that causes the conveyance of at least the amount for the generation of a build material layer.

At block 540, the controller 360 controls the drive mechanism 320 to move the non-powered platform 120 within the build compartment for an amount corresponding to the thickness of the subsequent layer of build material to be generated.

At block 550, the controller 360 controls a layer forming element (e.g., roller, wiper, doctor blade) from the 3D printer to spread the amount of build material from the feeding platform 260B to the build chamber 115 to generate the layer of build material.

Additionally, in some examples, the controller 360 may also control a controllable locking mechanism 350 from the 3D printer to engage with the locking interface 150 from the 3D printing apparatus to secure the 3D printing apparatus to the 3D printer.

As used herein, the terms “substantially” and “about” are used to provide flexibility to a range endpoint by providing a degree of flexibility. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printing apparatus comprising:
a build compartment defining a build chamber within which a 3D object is to be generated;
a non-powered platform, moveable within the build chamber, comprising a platform drive interface to engage with an external drive mechanism to cause the platform to move;
a locking interface to couple the 3D printing apparatus with an external hosting device;
a powder compartment located laterally adjacent to the build compartment, within which build material is to be stored for use in the generation of the 3D object.

Feature set 2: A 3D printing apparatus with feature set 1 configured as a non-powered single transportable element.

Feature set 3: A 3D printing apparatus with any preceding feature set 1 to 2, further comprising a non-powered feeding platform, moveable within the powder compartment, comprising a feeding platform drive interface to engage with an external powder feeding platform drive mechanism to cause the feeding platform to move.

Feature set 4: A 3D printing apparatus with any preceding feature set 1 to 3, wherein the powder compartment further comprises: a powder holder located at a top part of the powder compartment to accumulate build material thereon; and an Archimedes screw engageable with an external Archimedes screw engageable with an external Archimedes screw drive mechanism and controllable to transport build material from the powder compartment onto the powder holder.

Feature set 5: A 3D printing apparatus with any preceding feature set 1 to 4, wherein the build chamber and the powder compartment are about the same size.

Feature set 6: A 3D printing apparatus with any preceding feature set 1 to 5, further comprising an additional powder compartment located laterally adjacent to the build compartment and at the opposite side from powder compartment with respect the build compartment, the additional powder compartment to store build material for use in the generation of the 3D object.

Feature set 7: A hosting device comprising:
a 3D printing apparatus receiving interface to receive an external 3D printing apparatus that comprises:
   a build compartment and a powder compartment in lateral contact with each other,
   a non-powered platform moveable within the build compartment, and
   a locking interface;
a locking mechanism engageable with the locking interface to secure the 3D printing apparatus to the hosting device;
a drive mechanism engageable with the non-powered platform to cause the platform to move;
a controller to control the drive mechanism to move the platform within the build compartment.

Feature set 8: A hosting device with preceding feature set 7, further comprising a powder feeding platform drive mechanism engageable with a non-powered feeding platform in the powder compartment, to cause the feeding platform to move.

Feature set 9: A hosting device with any preceding feature set 7 to 8, wherein the controller is further to control the powder feeding platform drive mechanism to move the non-powered feeding platform for a predetermined distance.

Feature set 10: A hosting device with any preceding feature set 7 to 9, wherein the predetermined distance is based on an amount of build material to generate a layer of build material in a 3D printing operation.

Feature set 11: A hosting device with any preceding feature set 7 to 10 further comprising an Archimedes screw drive mechanism engageable with an Archimedes screw located in the powder compartment, to move build material from the powder compartment to a powder holder located at a top portion of the powder compartment.

Feature set 12: A hosting device with any preceding feature set 7 to 11, wherein the controller is further to control the Archimedes screw to rotate for a predetermined amount.

Feature set 13: A hosting device with any preceding feature set 7 or 12, wherein the hosting device is included in at least one of a 3D printer, a 3D build material processing station and/or a 3D printing curing station.

Feature set 14: A hosting device with any preceding feature set 7 or 13, wherein the drive mechanism further comprises a heating element to heat the platform.

Feature set 15: A 3D printer comprising:
A hosting device comprising:
a 3D printing apparatus receiving interface to receive an external 3D printing apparatus that comprises:
a build compartment and a powder compartment in lateral contact with each other,
a non-powered platform moveable within the build compartment,
a non-powered feeding platform moveable within the powder compartment, and
a locking interface;
a locking mechanism engageable with the locking interface to secure the 3D printing apparatus to the hosting device;
a drive mechanism engageable with the non-powered platform to cause the platform to move;
a powder feeding platform drive mechanism engageable with the non-powered feeding platform; and
a controller to:
   control the powder feeding platform drive mechanism to move the non-powered feeding platform for a predetermined distance, and
   control the drive mechanism to move the non-powered platform within the build compartment for an amount corresponding to a layer of build material.

What it is claimed is:

1. A 3D printing apparatus comprising:
a build compartment defining a build chamber within which a 3D object is to be generated;
a non-powered platform, moveable within the build chamber, comprising a platform drive interface to engage with an external drive mechanism to cause the platform to move;
a locking interface to couple the 3D printing apparatus with an external hosting device;
a powder compartment located laterally adjacent to the build compartment, within which build material is to be stored for use in the generation of the 3D object.

2. The 3D printing apparatus of claim 1 configured as a non-powered single transportable element.

3. The 3D printing apparatus of claim 1, further comprising a non-powered feeding platform, moveable within the powder compartment, comprising a feeding platform drive interface to engage with an external powder feeding platform drive mechanism to cause the feeding platform to move.

4. The 3D printing apparatus of claim 1, wherein the powder compartment further comprises:
a powder holder located at a top part of the powder compartment to accumulate build material thereon; and
an Archimedes screw engageable with an external Archimedes screw drive mechanism and controllable to transport build material from the powder compartment onto the powder holder.

5. The 3D printing apparatus of claim 1, wherein the build chamber and the powder compartment are about the same size.

6. The 3D printing apparatus of claim 1, further comprising an additional powder compartment located laterally adjacent to the build compartment and at the opposite side from powder compartment with respect the build compartment, the additional powder compartment to store build material for use in the generation of the 3D object.

7. A hosting device comprising:
a 3D printing apparatus receiving interface to receive an external 3D printing apparatus that comprises:
a build compartment and a powder compartment in lateral contact with each other,
a non-powered platform moveable within the build compartment, and
a locking interface;
a locking mechanism engageable with the locking interface to secure the 3D printing apparatus to the hosting device;
a drive mechanism engageable with the non-powered platform to cause the platform to move;
a controller to control the drive mechanism to move the platform within the build compartment.

8. The hosting device of claim 7, further comprising a powder feeding platform drive mechanism engageable with a non-powered feeding platform in the powder compartment, to cause the feeding platform to move.

9. The hosting device of claim 8, wherein the controller is further to control the powder feeding platform drive mechanism to move the non-powered feeding platform for a predetermined distance.

10. The hosting device of claim 9, wherein the predetermined distance is based on an amount of build material to generate a layer of build material in a 3D printing operation.

11. The hosting device of claim 7, further comprising an Archimedes screw drive mechanism engageable with an Archimedes screw located in the powder compartment, to move build material from the powder compartment to a powder holder located at a top portion of the powder compartment.

12. The hosting device of claim 11, wherein the controller is further to control the Archimedes screw to rotate for a predetermined amount.

13. The hosting device of claim 7, wherein the hosting device is included in at least one of a 3D printer, a 3D build material processing station and/or a 3D printing curing station.

14. The hosting device of claim 7, wherein the drive mechanism further comprises a heating element to heat the platform.

15. A 3D printer comprising:
A hosting device comprising:
a 3D printing apparatus receiving interface to receive an external 3D printing apparatus that comprises:
a build compartment and a powder compartment in lateral contact with each other,
a non-powered platform moveable within the build compartment,
a non-powered feeding platform moveable within the powder compartment, and
a locking interface;
a locking mechanism engageable with the locking interface to secure the 3D printing apparatus to the hosting device;
a drive mechanism engageable with the non-powered platform to cause the platform to move;
a powder feeding platform drive mechanism engageable with the non-powered feeding platform; and
a controller to:
control the powder feeding platform drive mechanism to move the non-powered feeding platform for a predetermined distance, and
control the drive mechanism to move the non-powered platform within the build compartment for an amount corresponding to a layer of build material.
